(19) United States
(12) Patent Application Publication
(10) Pub. No.: US 2010/0145952 A1
(43) Pub. Date: Jun. 10, 2010

(54) ELECTRONIC DOCUMENT PROCESSING APPARATUS AND METHOD

(76) Inventors: Yeo Chan YOON, Daejeon (KR); Myung Gil Jang, Daejeon (KR); HyunKi Kim, Daejeon (KR); YiGyu Hwang, Daejeon (KR); Soojong Lim, Daejeon (KR); Jeong Heo, Daejeon (KR); Chung Hee Lee, Daejeon (KR); Hyo-Jung Oh, Daejeon (KR); Changki Lee, Daejeon (KR); Miran Choi, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/635,042

(22) Filed: Dec. 10, 2009

(30) Foreign Application Priority Data
Dec. 10, 2008 (KR) 10-2008-0125438

(51) Int. Cl. G06F 17/30

(52) U.S. Cl. 707/747; 707/E17.052

(57) ABSTRACT

An electronic document processing apparatus includes: a document set storage unit storing hash tables including hash values of documents to be processed; a content extraction unit for extracting body contents from a newly input electronic document; and a sentence separation unit for separating sentences from the extracted body contents. The apparatus further includes a duplicate document determination unit for converting the separated sentences into unique hash values by a hash algorithm, determining each of the separated checking if there is a duplicate sentence depending on whether or not there is a collision between the converted hash values and the hash values in the hash tables of the document set storage unit, and determining if the electronic document is a duplicate document based on the ratio of duplicate sentences to all of the sentences in the electronic document.

### CROSS-REFERENCE(S) TO RELATED APPLICATION

The present invention claims priority of Korean Patent Application No. 10-2008-0125438, filed on Dec. 10, 2008, which is incorporated herein by reference.

### FIELD OF THE INVENTION

The present invention relates to a technique of processing duplicate documents, and more particularly, to an electronic document processing apparatus and method capable of determining an electronic document as a duplicated document when it has duplicate contents which is already present in other documents in a file system.

### BACKGROUND OF THE INVENTION

As well-known in the art, the growth of the web has led to the creation of electronic documents with various topics, and it is common for a user to scrap documents created by other people and to post them to their own blog or site. This often results in an increasing number of electronic documents with duplicate body content registered in the web. Due to this, systems, such as web/blog search and query answering systems, search and index the same electronic documents multiple times, thus decreasing user satisfaction.

To address this problem, there have been proposed duplicate document removal techniques, which can increase the performance of document processing by detecting and removing a document with duplicate content between electronic documents, such as blog documents, web documents, and the like, and other electronic documents. One of typical techniques of removing a duplicate document is a syntax filtering method in which contents of an electronic document is extracted, converted by a hash function into hash values having a one-to-one correspondence with numeric values, and determined as a duplicate document in the event of collision of the hash values. However, the determination of a duplicate document using this syntax filtering method has a problem in that a change of even 1 bit of the contents of an electronic document makes it impossible to determine the electronic document as a duplicate document.

In order to overcome this problem, there has been proposed a complementary method, which excludes frequently occurring words, such as particles and pronouns, from an entire document set, converts only the remaining important words into hash values, and then determines if a corresponding document is a duplicate.

The complementary method for the conventional syntax filtering method is easy to determine a duplicate document even if the contents of the document has been changed due to deletion or addition of frequently used words from or to the entire document set. However, an error may occur in the determination of a duplicate document because all or most words can be excluded from a short-length document or an electronic document containing only frequently used words. Moreover, the addition of only one or two important words not frequently used may cause an error in the determination of a duplicate document.

### SUMMARY OF THE INVENTION

Therefore, the present invention provides an electronic document processing apparatus and method capable of determining an electronic document as a duplicated document when it has duplicate contents which is already present in a existing document group.

In accordance with an aspect of the present invention, there is provided an electronic document processing apparatus including: a document set storage unit storing hash tables including hash values of documents to be processed; a content extraction unit for extracting body contents from a newly input electronic document; a sentence separation unit for separating sentences from the extracted body contents; and a duplicate document determination unit for converting the separated sentences into unique hash values by a hash algorithm, determining each of the separated checking if there is a duplicate sentence depending on whether or not there is a collision between the converted hash values and the hash values in the hash tables of the document set storage unit, and determining if the electronic document is a duplicate document based on the ratio of duplicate sentences to all of the sentences in the electronic document. In accordance with another aspect of the present invention, there is provided an electronic document processing method including: extracting body contents from a newly input electronic document; separating sentences from the extracted body contents; and converting the separated individual sentences into unique hash values by a hash algorithm; determining duplicate sentences among the separate sentences when there is(are) a collision(s) between the hash values of separate sentences and hash values of existing documents pre-stored in a document set storage unit.

### BRIEF DESCRIPTION OF THE DRAWINGS

The above and other objects and features of the present invention will become apparent from the following description of embodiments, given in conjunction with the accompanying drawings, in which:

FIG. 1 shows a unit diagram of an electronic document processing apparatus to determine whether a document has duplicate contents which is already present in existing documents in a file system in accordance with an embodiment of the present invention;

FIG. 2 illustrates a unit diagram of a duplicate document determination unit to determine if a corresponding document is a duplicate depending on whether or not each sentence in the document is a duplicate and the ratio of duplicate sentences in accordance with an embodiment of the present invention;

FIG. 3 is a flowchart showing a process of determining a duplicate document based on the presence of a duplicate sentence and the ratio of duplicate sentences in accordance with one embodiment of the present invention;

FIGS. 4A and 4B are views illustrating duplicate documents; and

FIGS. 5A and 5B are views illustrating an original document and an electronic document with additional contents.

### DETAILED DESCRIPTION OF THE EMBODIMENT

Hereinafter, the operational principle of the present invention will be described in detail with reference to the accompanying drawings which form a part hereof.

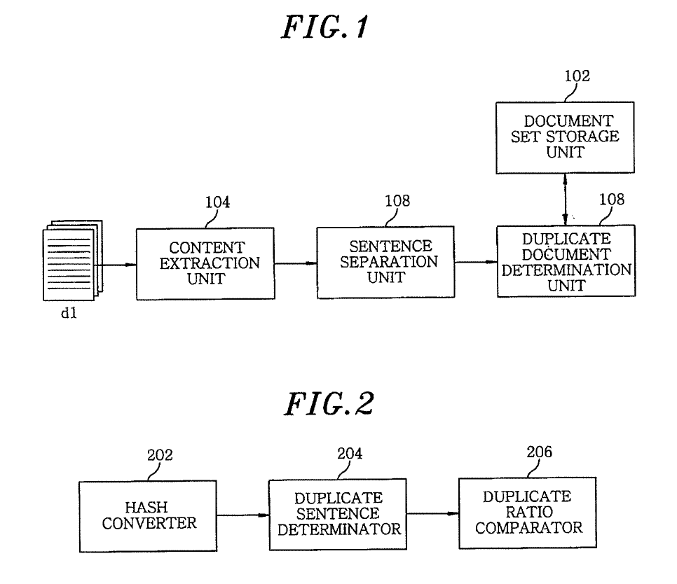

FIG. 1 shows a unit diagram of an electronic document processing apparatus suitable to determine whether a specific document has contents duplicating in existing documents in a file system in accordance with an embodiment of the present invention. The electronic document processing apparatus includes a document set storage unit 102, a content extraction unit 104, a sentence separation unit 106, and a duplicate document determination unit 108.

Referring to FIG. 1, the document set storage unit 102 stores large-volume electronic documents to be processed such as blog documents, web documents and the like. The documents stored in the document set storage unit 102 share limited duplicated contents depending on a preset duplication ratio value and each of the documents is stored in a state of a hash table made by using hash algorithm. The document set storage unit 102 provides the hash tables to the duplicate document determination unit 108 for determining presence of duplicating contents between a newly input document and the stored documents in the document set storage unit 102. Further, the documents set storage unit 102 receives and stores a hash table of a newly input document when it is determined to have duplicating contents with a granted ratio by the duplicate document determination unit 108.

The content extraction unit 104 is input with a new electronic document d1 extracts body contents of the input document d1 and transfers it to the sentence separation unit 106. Here, the electronic document d1 may have documents formats such as HTML, TXT, DOC, PDF and the like.

The sentence separation unit 106 separates the body contents of the electronic document d1 transferred from the content extraction unit 104 into sentences by a morpheme analyzer, a sentence separator or the like, and then transfers each of the separated sentences to the duplicate document determination unit 108.

The duplicate document determination unit 108 converts individual sentences into unique hash values by a hash algorithm, such as message-digest algorithm 5 (md5), and checks if there is a collision, i.e., oneness, between the converted hash values and hash values in the hash tables transmitted from the document set storage unit 102. If there is a collision, the corresponding sentence is determined as a duplicate sentence, and if not, the corresponding sentence is determined as a non-duplicate sentence. In addition, the duplicate document determination unit 108 calculates the number of duplicate sentences based on a result of determination on all the sentences in the corresponding electronic document d1, and calculates the ratio of duplicate sentences to all of the sentences. Then, if the ratio of duplicate sentences exceeds a preset ratio value, the corresponding electronic document d1 is determined as a duplicate document and excluded from documents to be processed, and if the ratio of duplicate sentences does not exceed the preset ratio value, the corresponding electronic document d1 is included in the documents to be processed in the file system and the hash values of the sentences in the electronic document d1 are stored in the document set storage unit 102.

Through such a process of comparing and checking the ratio of duplicate sentences, a system requiring to remove as many duplicate documents as possible is able to set the duplicate ratio to be low to determine a great deal of electronic documents as duplicate documents and remove them, while a system requiring to search as many electronic documents as possible is able to set the duplicate ratio to a high value to search a great deal of electronic documents and include them in documents to be processed.

Hereinafter, a process including: determining duplicate sentences by comparing hash values of separated sentences in a newly input document with hash values in hash tables provided from the document set storage unit 102; and determining a duplicate document by comparing the ratio of duplicate sentences to all of the sentences in the input documents with a preset ration value will be described by referring to FIG. 2.

FIG. 2 illustrates a detailed unit diagram of the duplicate document determination unit 108 shown in FIG. 1. The duplicate document determination unit 108 includes a hash converter 202, a duplicate sentence determinator 204, and a duplicate ratio comparator 206.

Referring to FIG. 2, the hash converter 202 converts each of the separated sentences transferred from the sentence separation unit 106 into a unique hash value by a hash algorithm such as md5, and transfers the hash value to the duplicate sentence determinator 204.

The duplicate sentence determinator 204 compares the hash values from the hash converter 202 with the hash values in the hash tables transferred from the document set storage unit 102, checks if there is a collision, i.e., oneness. If there is a collision, the duplicate sentence determinator determines the corresponding sentence as a duplicate sentence, and if not, determines the corresponding sentence as a non-duplicate sentence. Here, the duplicate sentence determinator 204 checks if there is a collision with respect to the hash values of all of the sentences in the input electronic document d1, and transfers the checking results to the duplicate ratio comparator 206.

The duplicate ratio comparator 206 receives the checking results on collision from the duplicate sentence determinator 204 to calculate the number of duplicate sentences, and calculates the ratio of duplicate sentences to all of the sentences in the electronic document d1. If the calculated ratio of duplicate sentences exceeds a preset ratio value, the corresponding electronic document d1 is determined as a duplicate document and excluded from the documents to be processed, and if the ratio of duplicate sentences does not exceed the preset ratio value, the corresponding electronic document d1 is included in the documents to be processed in the file system and stored in the document set storage unit 102.

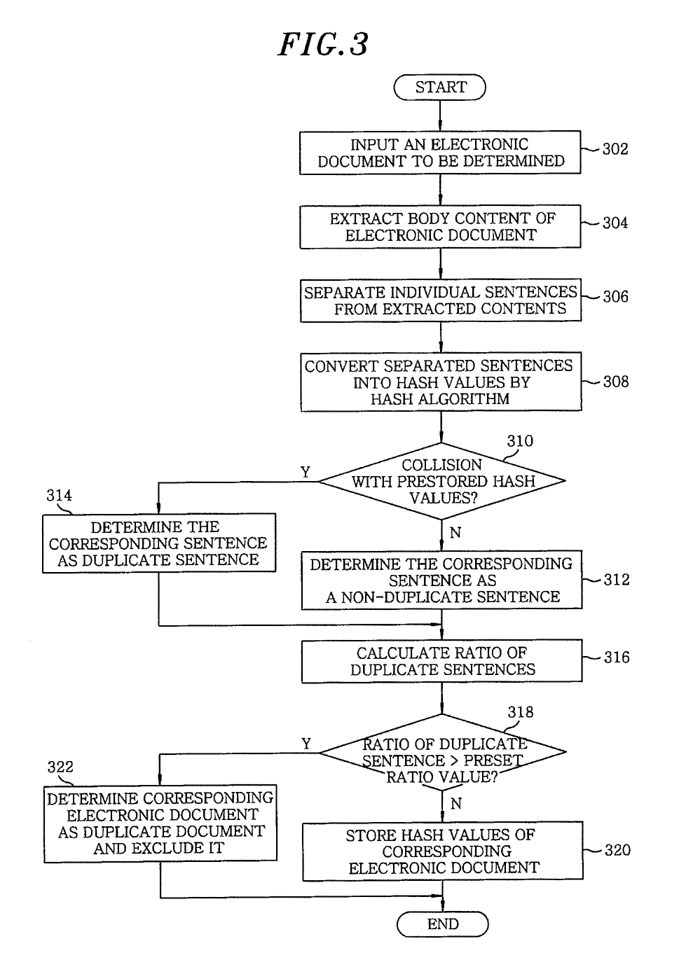

FIG. 3 is a flowchart showing a process of determining a duplicate document based on the presence of a duplicate sentence and the ratio of duplicate sentences in accordance with the embodiment of the present invention.

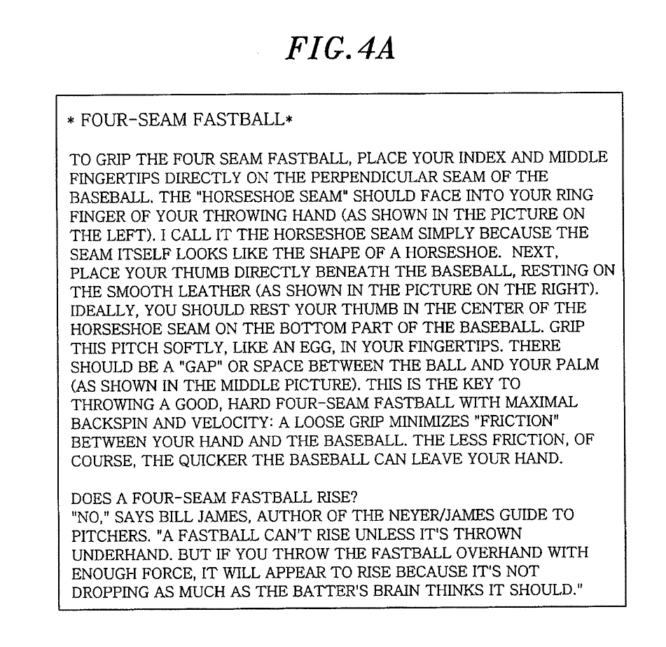

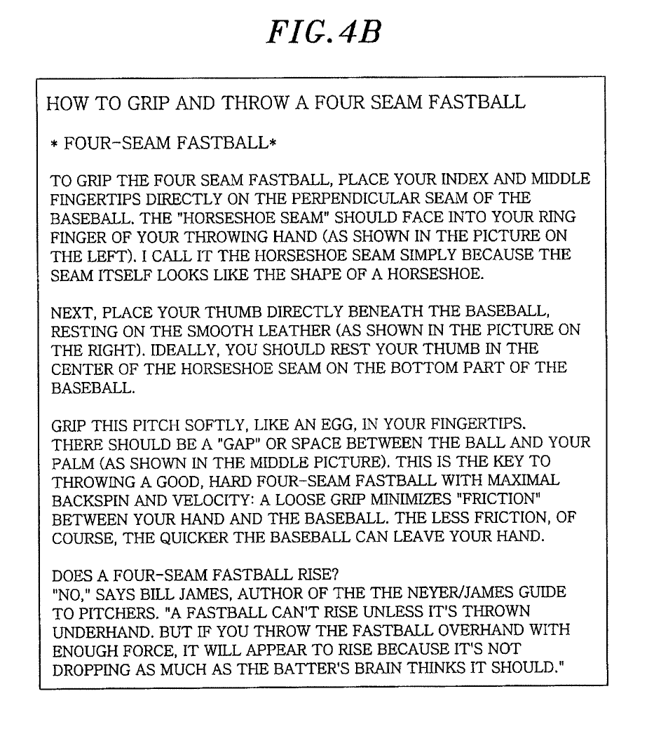

Referring to FIG. 3, when an electronic document to be determined d1 is input at step 302, the content extraction unit 104 extracts body contents of the electronic document d1 except additional information (e.g., a title, a poster, source and the like) at step 304. Here, the electronic document d1 may have document formats of HTML, TXT, DOC, PDF and the like. In one example, FIGS. 4A and 4B are views illustrating duplicate documents, which show an example in which the contents of an electronic document on ‘fastball’ as shown in FIG. 4A is scrapped and configured in the content of a different electronic document as shown in FIG. 4B.

Next, at step 306, the sentence separation unit 106 separates the contents of the electronic document d1 transferred from the document separation unit 104 into sentences by a morpheme analyzer, a sentence separator, or the like, and then transfers each of the separated sentences to the duplicate document determination unit 108.

Then, at step 308, the hash converter 202 of the duplicate document determination unit 108 converts the separated sentences from the sentence separation unit 106 into unique hash values by using a hash algorithm such as md5, and transfers these hash values to the duplicate sentence determinator 204.

Thereafter, at step 310, the duplicate sentence determinator 204 compares the hash value of each sentence from the hash converter 202 with the hash values in the hash tables transferred from the document set storage unit 102 and checks if there is a collision.

As a result of checking at step 310, if there is no collision, at step 312, the duplicate sentence determinator 204 determines the corresponding sentence as a non-duplicate sentence. If there is a collision, at step 314, the duplicate sentence determinator 204 determines the corresponding sentence having the corresponding hash values as a duplicate sentence. Here, the duplicate sentence determinator 204 checks if there is a collision with respect to the hash values of all of the sentences in the electronic document d1, and transfers the checking results to the duplicate ratio comparator 206.

Next, at step 316, the duplicate ratio comparator 206 receives the checking results on collision from the duplicate sentence determinator 204 to calculate the number of duplicate sentences, and calculates the ratio of duplicate sentences to all of the sentences.

Then, at step 318, the duplicate ratio comparator 206 checks whether the calculated ratio of duplicate sentences exceeds a preset ratio value.

As a result of checking in step 318, if the calculated ratio of duplicate sentences does not exceed the preset ratio value, at step 320, the duplicate ratio comparator 206 includes the corresponding electronic document d1 in the documents to be processed and stores the hash values of the sentences in electronic documents in the document set storage unit 102.

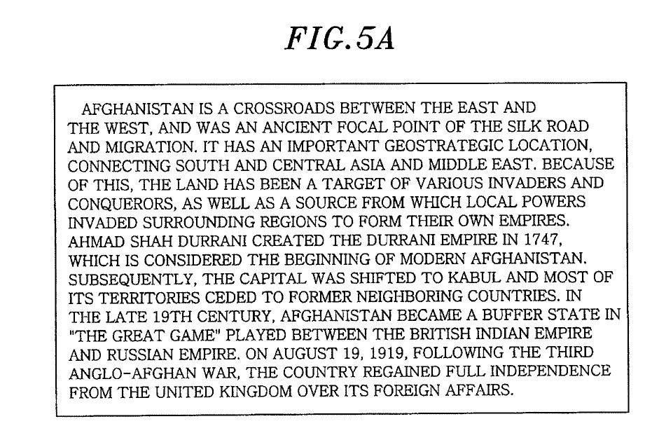

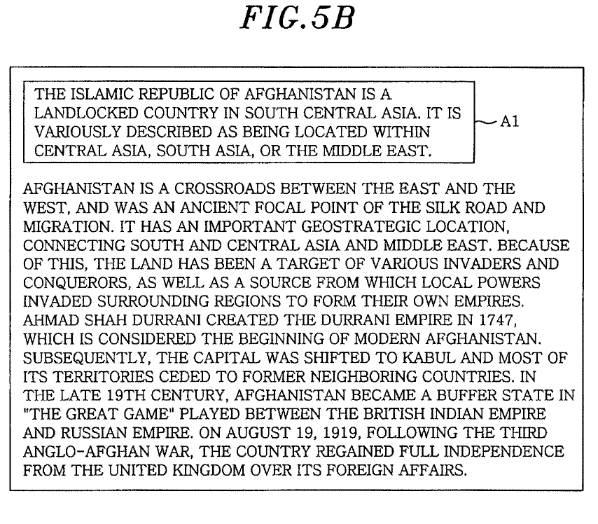

On the other hand, as a result of checking in step 318, if the calculated ratio of duplicate sentences exceeds the preset ratio value, in step 322 the duplicate ratio comparator 206 excludes the corresponding electronic document d1 from the documents to be processed. For example, FIGS. 5A and 5B are views respectively illustrating an original document stored in the document set storage unit and a newly input electronic document. Although the input electronic document includes additional contents A1, the ratio of duplicate sentences is relatively very high, and thus this electronic document can be determined as a duplicate document.

In summary, the body contents of an electronic document is extracted to determine if the electronic document is a duplicate document, the extracted body content is separated into individual sentences, the sentences are converted into hash values by a hash algorithm, the hash values are compared with prestored hash values to determine a colliding sentence as a duplicate sentence. Thus, it can be easily determined if the corresponding electronic document is a duplicate document based on the ratio of duplicate sentences in the electronic document. In this way, the present invention can be applied to systems requiring electronic document processing, such as a query answering system, a web/blog search system, an information search system and the like to effectively reduce documents to be processed, thereby increasing the efficiency of indexing, search, and query answering and improving user satisfaction.

While the invention has been shown and described with respect to the particular embodiments, it will be understood by those skilled in the art that various changes and modifications may be made without departing from the scope of the invention as defined in the following claims.

What is claimed is:

1. An electronic document processing apparatus comprising:
a document set storage unit storing hash tables including hash values of documents to be processed;
a content extraction unit for extracting body contents from a newly input electronic document;
a sentence separation unit for separating sentences from the extracted body contents; and
a duplicate document determination unit for converting the separated sentences into unique hash values by a hash algorithm, determining each of the separated checking if there is a duplicate sentence depending on whether or not there is a collision between the converted hash values and the hash values in the hash tables of the document set storage unit, and determining if the electronic document is a duplicate document based on the ratio of duplicate sentences to all of the sentences in the electronic document.

2. The apparatus of claim 1, wherein the duplicate document determination unit includes:
a hash converter for converting the separated sentences into unique hash values by using the hash algorithm;
a duplicate sentence determinator for comparing the converted hash values with the hash values in the hash table, and determining the corresponding sentence as a duplicate sentence if there is a hash value collision; and
a duplicate ratio comparator for determining the electronic document as a duplicate document if the ratio of duplicate sentences to the all sentences in the electronic document exceeds a preset ratio value and determining the electronic document as a non-duplicate document otherwise.

3. The apparatus of claim 2, wherein the duplicate ratio comparator stores the hash values of the sentence in the electronic document into the document set storage unit when the electronic document is determined to be non-duplicated document.

4. The apparatus of claim 1, wherein the hash algorithm is a message-digest algorithm 5 (md5).

5. The apparatus of claim 1, wherein the electronic document has one of formats including HTML, TXT, DOC and PDF.

6. An electronic document processing method comprising:
extracting body contents from a newly input electronic document;
separating sentences from the extracted body contents; and
converting the separated individual sentences into unique hash values by a hash algorithm;
determining duplicate sentences among the separate sentences when there is(are) a collision(s) between the hash values of separate sentences and hash values of existing documents pre-stored in a document set storage unit; and
determining whether the electronic document is a duplicate document based on a ratio of the duplicate sentences to all sentences in the electronic document.

7. The method of claim 6, wherein the hash algorithm is a message-digest algorithm 5 (md5).

8. The method of claim 6, wherein the electronic document has one of formats including HTML, TXT, DOC and PDF.

9. The method of claim 6, wherein, in said determining whether the electronic document is a duplicate document, if the ratio of duplicate sentences to all sentences in the electronic document exceeds a preset ratio value, the electronic document is determined as a duplicate document and otherwise, the electronic document is determined as a non-duplicate document.

10. The method of claim 9, wherein, when the electronic document is determined as the non-duplicate document, the hash values of the separate sentences in the electronic document is stored into the document set storage unit.
